(19) United States
(12) Patent Application Publication
(10) Pub. No.: US 2024/0392818 A1
(43) Pub. Date: Nov. 28, 2024

(54) Multi-Piece Modular Retainer

(71) Applicant: Illinois Tool Works Inc., Glenview, IL (US)

(72) Inventor: Mark Beyer, Armada, MI (US)

(21) Appl. No.: 18/649,819

(22) Filed: Apr. 29, 2024

Related U.S. Application Data
(60) Provisional application No. 63/468,610, filed on May 24, 2023.

(51) Int. Cl. F16B 5/02; F16B 37/04

(52) U.S. Cl. CPC F16B 5/0258; F16B 37/044

(57) ABSTRACT

Described is a retainer assembly for attaching a first component having a first opening relative to a second component having a second opening. The retainer assembly includes a nut insert and a stamped-metal retainer clip. The nut insert includes a collar and a flange where the collar defines a bore that engages a shank of a fastener. The nut insert may be a non-hardened ferrous nut insert. The stamped-metal retainer clip includes a nut recess that receives and retains the nut insert. The stamped-metal retainer clip includes first planar portion and a second planar portion that are resiliently connected via a sidewall to define a channel, a nut base plate resiliently connected to the first planar portion and extending into the channel, and a tongue resiliently coupled to the first planar portion and configured to secure a least a portion of the nut insert between the tongue and the base plate. The tongue can include a tongue opening configured to receive a portion of the collar.

### RELATED APPLICATIONS

The present application claims priority to U.S. Provisional Patent Application No. 63/468,610, filed May 24, 2023, and entitled “Rivet Nut” which is hereby incorporated by reference in its entirety.

### BACKGROUND

Automotive components necessitate fastening techniques that prioritize simplicity in manufacturing and assembly while maintaining reliability and efficiency. One commonly utilized method involves the integration of stamped metal clips with fasteners.

Among these fasteners, metal spring-loaded components like U-nut fasteners (also recognized as J-nuts or speed nuts) often incorporate a retainer with an internally threaded bore. This design feature streamlines installation processes, eliminating the need for rear access to the fastening point. Widely utilized across automotive, aerospace, and electronic industries, these fasteners ensure robust and lasting attachment of components such as body panels, interior trim, and electrical enclosures. However, during assembly, current spring-loaded fastening components can become damaged (e.g., stripped), necessitating replacement of the entire fastening component. Furthermore, current spring-loaded fastening components are restricted in their compatibility with different fastener types, constrained by the specific thread type utilized in the internally threaded bore.

Therefore, despite existing advancements, a need exists for a multi-piece modular retainer that offers enhanced versatility and adaptability in fastening applications.

### SUMMARY

The present disclosure relates generally to a multi-piece retainer assembly to form a connection between two components, such as vehicular components, substantially as illustrated by and described in connection with at least one of the figures, as set forth more completely in the claims. In some examples, the multi-piece retainer assembly comprises a modular, interchangeable multi-piece retainer assembly that allows a user to use replace damaged inserts or to accommodate various nuts in the same carrier.

### DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 illustrates a topside isometric assembly view of a fastening system having a retainer assembly in accordance with an aspect of this disclosure.

FIG. 2a illustrates a side elevation assembly view of the fastening system of FIG. 1a with the first and second components omitted.

FIG. 2b illustrates an underside isometric assembly view of the fastening system of FIG. 1a with the first and second components omitted.

FIGS. 2c and 2d illustrate first and second side elevation assembled views of the fastening system of FIG. 1a with the first and second components omitted.

FIGS. 2e and 2f illustrate first and second cross-sectional views of the fastening system of FIG. 1a with the fastener and the first and second components omitted.

FIG. 3a illustrates a topside isometric view of a retainer clip of the retainer assembly in accordance with an aspect of this disclosure.

FIG. 3b illustrates an underside isometric view of the retainer clip.

FIGS. 3c and 3d illustrate first and second side elevation assembled views of the retainer clip.

FIGS. 3e and 3f illustrate, respectively, front and rear views of the retainer clip.

FIGS. 3g and 3h illustrate, respectively, top and bottom plan views of the retainer clip.

### DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

A rivet nut, also known as a blind rivet nut, threaded insert, or nutsert, is a fastener designed for situations where access to the opposite side of the material is limited or impractical. Made typically of metal, it features a cylindrical body with internal threads, often accompanied by a flange or head at one end and an open end at the other. A challenge in the use of rivet nuts and weld nuts predominantly revolves around the serviceability and reparability of the joint. When the threads of bolts are inadequately formed, the tasks associated with servicing, removing, or replacing a weld nut or rivet nut become unduly time-consuming. To mitigate these issues, disclosed is a retainer assembly that facilitates the swift replacement of the nut insert in instances of damage during installation, thereby enhancing overall efficiency.

The retainer assembly is composed of a non-hardened ferrous nut insert and a spring steel retainer clip, specifically engineered for compatibility with self-threading fasteners. Noteworthy features of the retainer assembly include a resiliently-attached tongue having a tongue opening or loop to maintain the nut insert in alignment relative to the fastener's position. Additionally, the retainer clip incorporates a plurality of upward-turned flanges (e.g., two or more, illustrated with four) designed to effectively thwart rotation of the nut insert during both insertion and torque application of the fastener. Furthermore, the clip retainer exhibits a shallow clip-to-panel retainer, which mitigates scratching or damage to a mating component or panel.

This retainer assembly offers several notable advantages. Firstly, it exhibits compatibility with a broad spectrum of component (e.g., panel) thicknesses. Secondly, it demands minimal installation effort. Thirdly, it effectively safeguards against scratching or damaging the mating component. Fourthly, it streamlines the typically intricate and time-intensive procedures associated with the installation of tradition weld nuts or rivet nuts. Finally, it simplifies the processes involved in servicing and repairing assemblies by offering a straightforward replacement mechanism for weld nuts or rivet nuts.

In one example, a retainer assembly for attaching a first component having a first opening relative to a second component having a second opening comprises: a nut insert comprises a bore configured to engaged a shank of a fastener, wherein the nut insert comprises a non-hardened ferrous material (e.g., a non-hardened ferrous material); and a retainer clip comprises a nut recess that is configured to receive and retain the nut insert, wherein the retainer clip comprises, a first planar portion and a second planar portion that are resiliently connected via a sidewall to define a channel, and a nut base plate resiliently connected to the first planar portion and extending into the channel.

In another example, a retainer assembly for attaching a first component having a first opening relative to a second component having a second opening comprises: a non-hardened ferrous nut insert comprises a collar and a flange, wherein the collar defines a bore that is configured to engaged a shank of a fastener; and a stamped-metal retainer clip comprises a nut recess that is configured to receive and retain the non-hardened ferrous nut insert, wherein the stamped-metal retainer clip comprises, a first planar portion and a second planar portion that are resiliently connected via a sidewall to define a channel, and a nut base plate resiliently connected to the first planar portion and extending into the channel.

In yet another example, a retainer assembly for attaching a first component having a first opening relative to a second component having a second opening comprises: a nut insert comprises a bore configured to engaged a shank of a fastener, wherein the nut insert comprises a non-hardened ferrous material; and a stamped-metal retainer clip comprises a nut recess that is configured to receive and retain the nut insert, wherein the retainer clip comprises, a first planar portion and a second planar portion that are resiliently connected via a sidewall to define a channel, a nut base plate resiliently connected to the first planar portion and extending into the channel, and one or more upward-turned flanges at a perimeter of the nut recess configured to mitigate rotation of the fastener relative to the nut base plate.

In some examples, the nut base plate is resiliently connected to the first planar portion via a sequence of bends. For example, the nut base plate can be resiliently connected to the first planar portion via a sequence of bends, which defines a guide lip adjacent an opening to the channel that is configured to guide the first component or the second component into the channel and between the nut base plate and the second planar portion.

In some examples, the retainer clip is a stamped-metal component.

In some examples, the channel is configured to receive and to secure the first component and the second component between the nut base plate and the second planar portion.

In some examples, the retainer clip comprises one or more upward-turned flanges configured to provide resistance to torque during assembly of the nut insert with the shank of the fastener.

In some examples, the nut insert comprises a collar and a flange, wherein the collar defines the bore.

In some examples, the stamped-metal retainer clip further comprises a tongue resiliently coupled to the first planar portion and configured to secure a least a portion of the nut insert between the tongue and the base plate. The tongue can define a tongue opening configured to receive a collar of the nut insert.

In some examples, the retainer clip comprises a guide lip positioned adjacent an opening to the channel that is configured to guide the first component or the second component into the channel and between the nut base plate and the second planar portion.

In some examples, the bore is not threaded and configured to accommodate a shank that is thread-forming.

In some examples, the nut base plate and the second planar portion collectively define a fastener passage to receive the shank therethrough.

In some examples, the nut base plate comprises one or more upward-turned flanges at a perimeter of the nut recess configured to mitigate rotation of the fastener relative to the nut base plate.

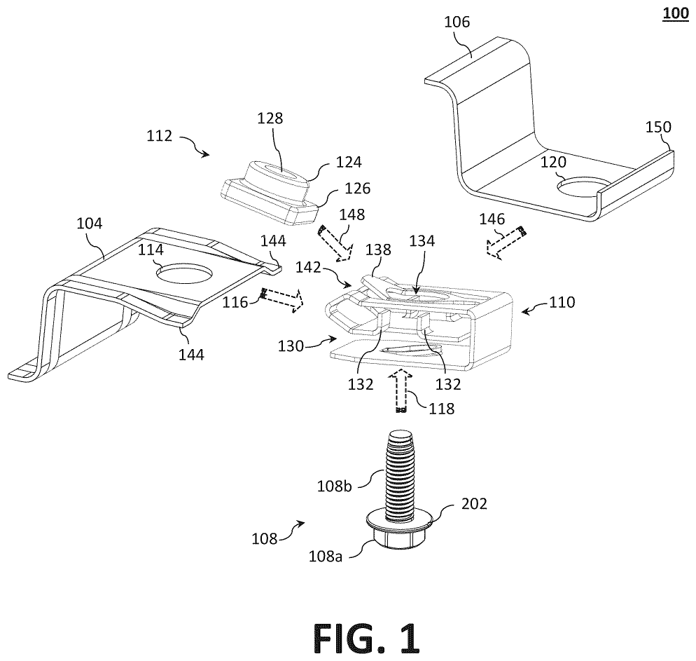

FIG. 1 illustrates a topside isometric assembly view of a fastening system 100 having a retainer assembly 102 and fastener 108 in accordance with an aspect of this disclosure. The retainer assembly 102 is configured to join the first component 104 and the second component 106. To facilitate attachment via the retainer assembly 102, each of the first component 104 and the second component 106 includes one or more engagement features. For example, the first component 104 is illustrated as having a first opening 114 formed therein and the second component 106 is illustrated as having a second opening 120 formed therein. In the illustrated example, each of the first opening 114 and the second opening 120 is circular and sized and shaped to receive a portion of the fastener 108.

The first opening 114 and the second opening 120 can be formed in the respective first component 104 or second component 106 during manufacturing thereof or added post-manufacture through a mechanical process (e.g., drilling, cutting, carving, etc.). After the first component 104 and the second component 106 are assembled, as illustrated, the second component 106 is covered at least partially by the first component 104.

The retainer assembly 102 is illustrated as a multi-component retainer assembly having a fastener 108 (e.g., an externally-threaded shaft, such as a bolt), a retainer clip 110 (e.g., a metal retainer clip, such as a U-nut fastener), and a nut insert 112 (e.g., a component with a bore, which can be smooth or internally-threaded). The retainer clip 110 serves to mechanically engage and couple with the first component 104 via the first opening 114, while the fastener 108 and the nut insert 112 serves to couple the first component (via the retainer clip 110) to the second component 106 (via its second opening 120).

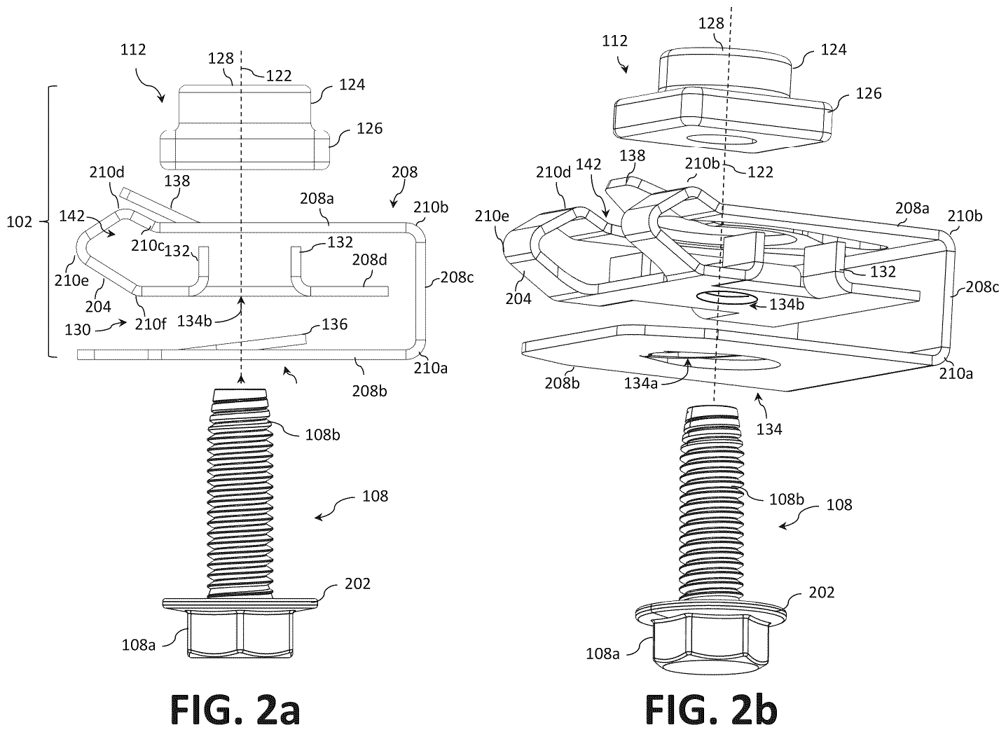

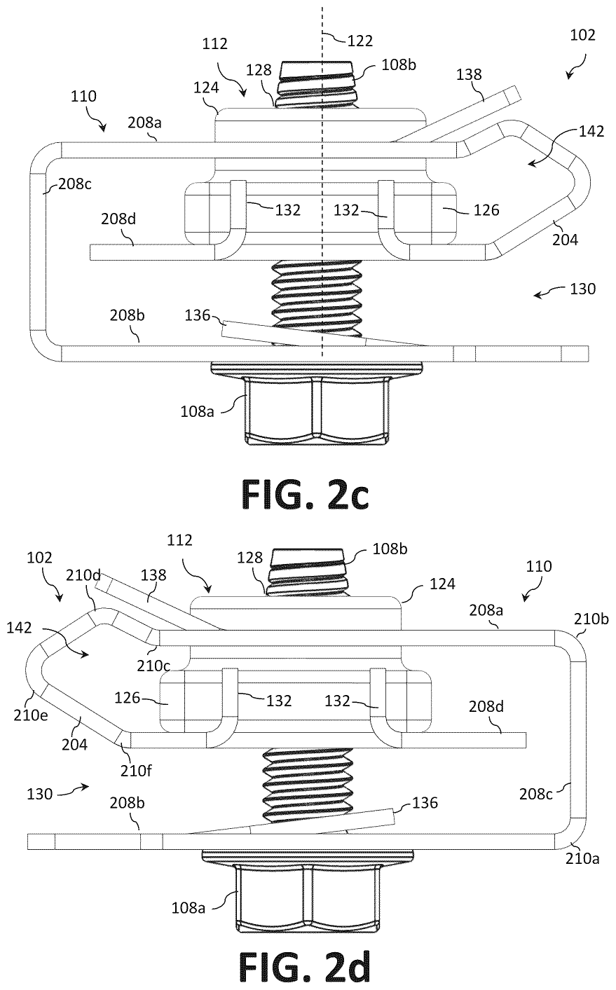

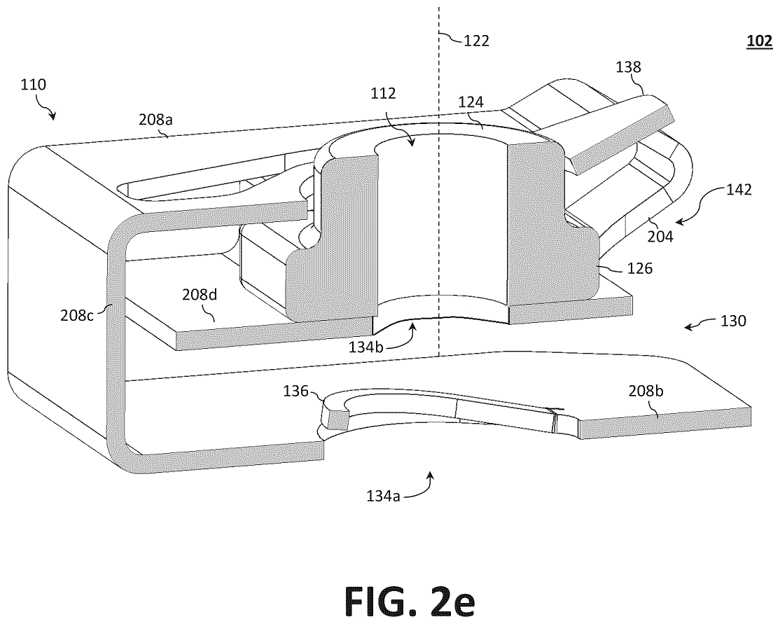

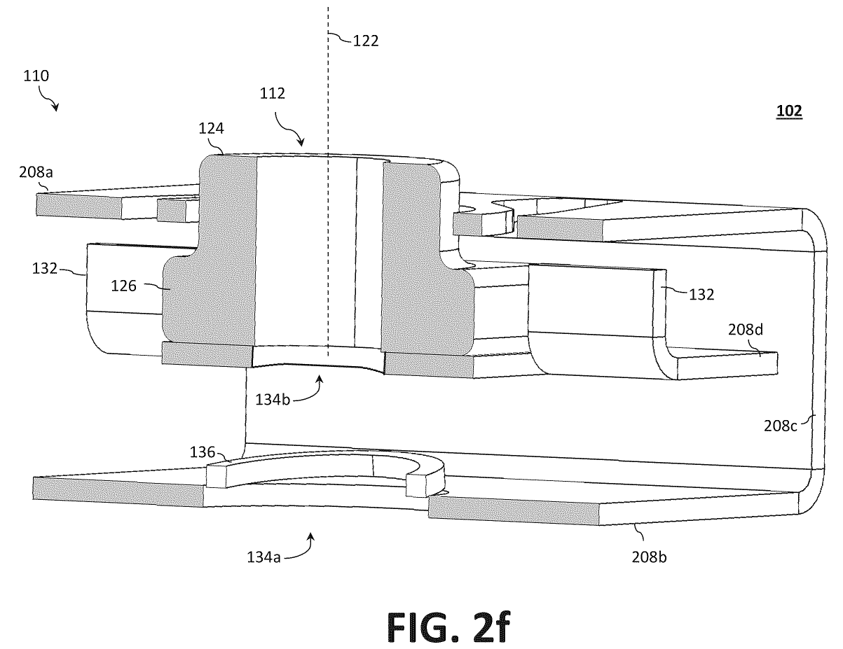

FIGS. 2a through 2d illustrate various views of the example fastening system 100 of FIG. 1a with the first and second components 104, 106 omitted to better illustrate the components of the retainer assembly 102. Specifically, FIGS. 2a and 2b illustrate side elevation and underside isometric assembly views of the fastening system 100, while FIGS. 2c and 2d illustrate first and second side elevation assembled views of the fastening system 100 of FIG. 1a with the first and second components 104, 106 omitted. FIGS. 2e and 2f illustrate first and second cross-sectional views of the fastening system 100 of FIG. 1a with the fastener 108 and the first and second components 104, 106 omitted.

As illustrated, the fastener 108 comprises a head 108a and a shank 108b. In the illustrated example, the head 108a is square and the shank 108b is threaded. While the fastener 108 is illustrated as a threaded bolt having a head 108a that is hexagonal, other types of fasteners are contemplated. For example, the fastener 108 is illustrated as a flanged bolt having a flange 202 between the head 108a and the threaded shank 108b.

The illustrated nut insert 112 comprise a collar 124, a flange 126, and a bore 128 configured to engage the shank 108b.

In some the illustrated example, the bore 128 is smooth (e.g., featureless) and engineered for compatibility with self-threading fasteners 108. In other examples, the bore 128 is an internally-threaded bore configured to threadedly engage the shank 108b. The collar 124 is illustrated as cylindrical, but could also be shaped to facilitate tool engagement (e.g., hex-shaped, square, or otherwise). In this example, the nut insert 112 is rotationally fixed relative to the retainer clip 110. Therefore, the retainer assembly 102 includes one or more features to rotationally fix and secure the nut insert 112 to mitigating risk of loss of the nut insert 112.

The illustrated nut recess 142 includes one or more anti-rotation features 132 to interact with and mitigate rotation of the flange 126 and a resiliently-attached tongue 138 to receive the collar 124 via a tongue opening 140 and to apply a downward force upon the flange 126 (e.g., pressing the flange 126 against the nut base plate 208d). The resiliently-attached tongue 138 is configured as a retaining ring that is configured to secure the nut insert 112 in position. The flange 126 is shaped interact with the a nut recess 142 of the retainer clip 110 to mitigate rotation of the nut insert 112 relative to the nut recess 142. In the illustrated example, the flange 126 is a quadrilateral (illustrated as a square). With reference to FIGS. 2c and 2d, the illustrated anti-rotation features 132 comprise one or more upward-turned flanges configured to abut one or more sides of the flange 126 when installed, effectively serving as an anti-rotation wall or abutment structure. In the illustrated example, each of the one or more upward-turned flanges are substantially perpendicular to the nut base plate 208d (i.e., positioned approximately 90 degrees relative to the nut base plate 208d). While four upward-turned flanges (two on each side of the nut insert 112) are illustrated, additional or fewer upward-turned flanges can be employed.

The nut base plate 208d is configured to self-align and float to maintain the nut insert 112 perpendicularly relative to the fastener 108 regardless of panel thickness (i.e., thickness of the first and second panels 104, 106). More specially, the retainer clip 110 is configured to flex at one or more of its bends 210a, 210b, 210c, 210d, 210e, 210f to maintain the nut base plate 208d as substantially parallel to the second planar portion 208b.

The nut insert 112 can be removeably coupled with the retainer clip 110 (e.g., via the nut recess 142) to enable interchangeability of the nut insert 112, thus allowing the retainer clip 110 to be replaces or be used with various different nut inserts 112 to facilitate different type of fasteners 108 (e.g., those of different threading, diameters, size, materials, etc.). The nut insert 112 can be secured and/or retained relative to the nut recess 142/the retainer clip 110 via the tongue opening 140 and/or one or more anti-rotation features 132. As noted, the nut insert 112 can be a non-threaded nut insert to accommodate thread-forming fasteners 108. The retainer clip 110 can be sub-assembled with the nut insert 112 before being pressed onto a first component 104 and packaged as a part-in-assembly (PIA). While the nut insert 112 is illustrated in the form of a one-piece nut insert 112, in other examples, the nut insert 112 can be a multi-component piece.

In some examples, the retainer assembly 102 further comprises a seal when desirable to mitigate dust, dirt, and/or moisture penetration through one of the openings (e.g., the first opening 114, the second opening 120, the fastener passage 134, etc.). The seal may be embodied as a ring (e.g., an annulus) and fabricated from foam material, thermoplastic, rubber, etc. For example, a seal can be configured to surround a portion of the fastener 108 (e.g., the shank) and positioned between the second component 106 and nut insert 112. In some examples, a seal can be positioned around the shank 108b between the flange 126 and the second component 106 to form a liquid or gas barrier.

It is contemplated that certain components of the multi-component retainer assembly 102 may be fabricated as a stamped-metal component using a metal-stamping technique. For example, the retainer clip 110 can be fabricated from a single sheet of metal and stamped/bent using a metal-stamping technique, while the fastener 108 and/or the nut insert 112 can be fabricated from metal via one or more metal-shaping techniques, such as cold forging. In another example, the retainer clip 110 can be fabricated as a stamped-metal component, whereas the fastener 108 and the nut insert 112 can be fabricated from a plastic material using a plastic injection technique, additive manufacturing, or otherwise.

In one example, the nut insert 112 can be fabricated using a ferrous material that has not undergone a hardening process. The nut insert 112 can be ferrous in that it contains iron. In this context, “non-hardened” means that the nut has not been subjected to, for example, a heat treatment processes, such as quenching and tempering, which are commonly used to increase the hardness and strength of metal components. As a result, a nut insert 112 fabricated from a non-hardened ferrous is typically softer and more malleable compared to their hardened counterparts. In some examples, one or more components of the retainer assembly 102 may be fabricated using material extrusion (e.g., fused deposition modeling (FDM), stereolithography (SLA), selective laser sintering (SLS), material jetting, binder jetting, powder bed fusion, directed energy deposition, VAT photopolymerisation, and/or any other suitable type of additive manufacturing/3D printing process.

The first component 104 and the second component 106 may be, for example, automotive panels or other automotive components. Depending on the application, one or both of the first component 104 and/or the second component 106 may be fabricated from, for example, metal (or a metal alloy), synthetic or semi-synthetic polymers (e.g., plastics, such as acrylonitrile butadiene styrene (ABS) and polyvinyl chloride (PVC), etc.), composite materials (e.g., fiber glass), or a combination thereof. In the automotive industry, example first components 104 include, without limitation, door trim panels, moldings, trim pieces, and other substrates (whether used as interior or exterior surfaces). The second component 106 may be, for example, an automotive panel, a structural component of a vehicle, such as doors, pillars (e.g., an A-pillar, B-pillar, C-pillar, etc.), dashboard components (e.g., a cross member, bracket, frame, etc.), seat frames, center consoles, fenders, sheet metal framework, or the like. Depending on the application, the first component 104 and/or the second component 106 may be fabricated from, for example, metal (or a metal alloy), synthetic or semi-synthetic polymers (e.g., plastics, such as acrylonitrile butadiene styrene (ABS) and polyvinyl chloride (PVC), etc.), composite materials (e.g., fiber glass), or a combination thereof.

The first component 104 and the second component 106 are shaped such that they can interact with the interior geometry of the retainer clip 110. For example, the illustrated first component 104 defines a set of sloped wings 144 that are configured (e.g., sized, shaped, and spaced) to receive a portion of the retainer clip 110 therebetween to mitigate, for example, side-to-side movement between the first component 104 and the retainer clip 110. The illustrated second component 106 defines a wall 150 (e.g., illustrated as a 90-degree bend, but other angles are contemplated) at its distal edge that is configured to slide laterally into the channel 130 to mitigate, for example, pull out of the second component 106 from the retainer clip 110 in a direction opposite of arrow 116.

During installation, as best illustrated in FIG. 1, the nut insert 112 is inserted into the nut recess 142 of the retainer clip 110 as indicated by arrow 148 and retained via one or more anti-rotation features 132. In this example, the approach angle of the nut insert 112 indicated by the arrow 148 is slightly pitched or angled to enable the user to slip the nut insert 112 into the nut recess 142 and secured via the one or more anti-rotation features 132. The first component 104 is slid into the channel 130 of the retainer clip 110 as indicated by arrow 116 such that the first opening 114 aligns with the fastener passage 134. The second component 106 is slid into the channel 130 of the retainer clip 110 as indicated by arrow 146 such that the second opening 120 aligns with the fastener passage 134. In this example, the direction indicated by arrow 116 is substantially perpendicular to the direction indicated by arrow 146 as the second component 106 is slid into the channel 130 laterally to accommodate the wall 150.

Once the first opening 114, the second opening 120, and the fastener passage 134 are aligned (e.g., generally concentric and aligned with the axis of rotation 122), an end of the shank 108b is passed through each of the fastener passage 134 formed in the retainer clip 110, the first opening 114, and the second opening 120, as indicated by arrow 118 to ultimately engage the nut insert 112. The fastener 108 and/or the nut insert 112 can be rotated relative to one another about its axis of rotation 122 to join and compress the first component 104 and second component 106 relative to one another. For example, the fastener 108 can be rotated about its axis of rotation 122 via the head 108a.

With reference to FIGS. 2a through 2d, the illustrated retainer clip 110 comprises a body portion 208 that defines the channel 130 (e.g., a U-shaped channel) to receive the first component 104 and the second component 106 and the nut recess 142.

The illustrated body portion 208 is formed as a pair of first and second planar portions 208a, 208b that are resiliently connected at an end via a sidewall 208c (e.g., a spring clip). As illustrated, the first and second planar portions 208a, 208b are generally parallel and the sidewall 208c is shaped to accommodate a combined panel thickness for the first and second components 104, 106. The pair of opposing first and second planar portions 208a, 208b are resiliently connected at the sidewall 208c such that the pair of opposing first and second planar portions 208a, 208b default (e.g., spring back) to a predetermined shape. The channel 130 is sized to receive a least a portion of the first component 104 and the second component 106. In the illustrated example, the second planar portion 208b defines a first passage opening 134a. In the illustrated example, a panel tab 136 is also positioned at the fastener passage 134 (e.g., formed along the inner perimeter for the first passage opening 134a) and generally U-shaped to at least partially encircle or surround the shank 108b when assembled. In use, the panel tab 136 is configured to snap into a corresponding feature (e.g., on an adjacent component to creating audible/tactile feedback during installation.

The panel tab 136 can be positioned to define a small approach angle to mitigate potential scratched to one or both of the first and second components 104, 106. In this example, as illustrated in FIG. 2e, the panel tab 136 can be positioned to define a small approach angle to mitigate potential scratches to first component 104. The illustrated first planar portion 208a is stamped and bent to form a nut base plate 208d that is resiliently connected to the first planar portion 208a at one end adjacent a guide lip 204 at an opening to the channel 130. The guide lip 204 can be shaped at an angle to guide the first component into the channel 130 during assembly. In addition, the guide lip 204 can provide a bearing area for manipulation during assembly by an operator. For example, the nut base plate 208d can be resiliently connected to the first planar portion 208a via a sequence of bends 210c, 210d, 210e, 210f that define the guide lip 204 adjacent an opening to the channel 130 to guide the first component or the second component into the channel and between the nut base plate and the second planar portion.

As illustrated, the nut base plate 208d can be punched with the first planar portion 208a and bent to extend into the channel 130. In the illustrated example, the nut base plate 208d defines a second passage opening 134b and, together with the first passage opening 134a, defines the fastener passage 134. The nut base plate 208d is generally parallel to the first and second planar portions 208a, 208b and configured to sandwich the first and second components 104, 106 therebetween. While the first and second planar portions 208a, 208b are illustrated as parallel, the first and second planar portions 208a, 208b could be non-parallel to, for example, further facilitate a variable panel thickness.

In the illustrated example, the second planar portion 208b is resiliently connected to the sidewall 208c via a first bend 210a, typically forming a right angle, approximately 90 degrees. Similarly, the sidewall 208c is linked to the first planar portion 208a through a second bend 210b, also at a right angle. In this configuration, the first planar portion 208 connects to the nut base plate 208d through a sequence of bends (e.g., third, fourth, fifth, and sixth bends 210c, 210d, 210e, 210f). When these bends are in their default position (i.e., the clip retainer 110 is unloaded), their combined angle totals 180 degrees, ensuring parallel orientation of the nut base plate 208d and the second planar portion 208b. Upon insertion of components with various thicknesses into the channel 130, the clip retainer 110 flexes at or adjacent the sidewall 208c, particularly at the first and second bends 210a, 210b. In this case, the first planar portion 208a and the second planar portion 208b may become non-parallel Consequently, the third, fourth, fifth, and sixth bends 210c, 210d, 210e, 210f adjust dynamically to maintain the parallel orientation of the nut base plate 208d and the second planar portion 208b.

In addition to defining the second passage opening 134b, the nut base plate 208d defines serves as the base to the nut recess 142 and supports the nut insert 112 via a bottom surface of the flange 126. When assembled, the nut insert 112 resides within the nut recess 142 defined by the nut base plate 208d, the one or more anti-rotation features 132, and the tongue 138 such that it is prevented from rotating about its axis of rotation 122 via, inter alia, the sidewalls of the anti-rotation features 132.

The retainer clip 110 further comprises one or more anti-rotation features 132 at the nut base plate 208d to retain and rotationally fix the nut insert 112 by capturing the flange 126. The one or more anti-rotation features 132 can be positioned at one or more sides of the perimeter of the nut recess 142 (illustrated as being located at two, opposing sides). The flange 126 can snap through anti-rotation features 132 in the retainer clip 110. In the illustrated example, the nut base plate 208d includes two anti-rotation feature 132 (one on each side of the nut recess 142). The anti-rotation features 132 abut or otherwise rests against a surface of the flange 126 (e.g., a straight edge) to provide resistance to torque during assembly with the nut insert 112.

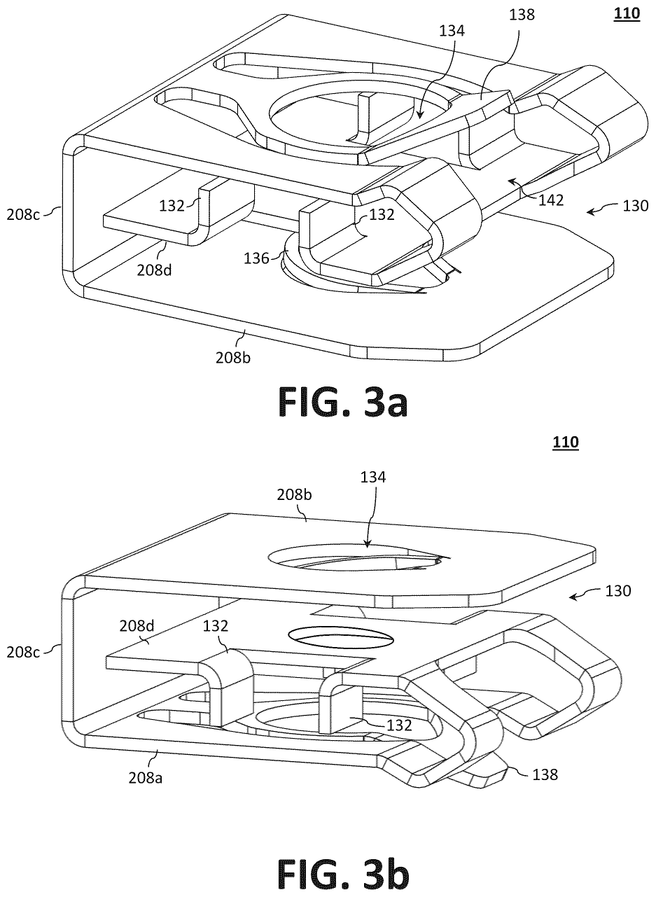

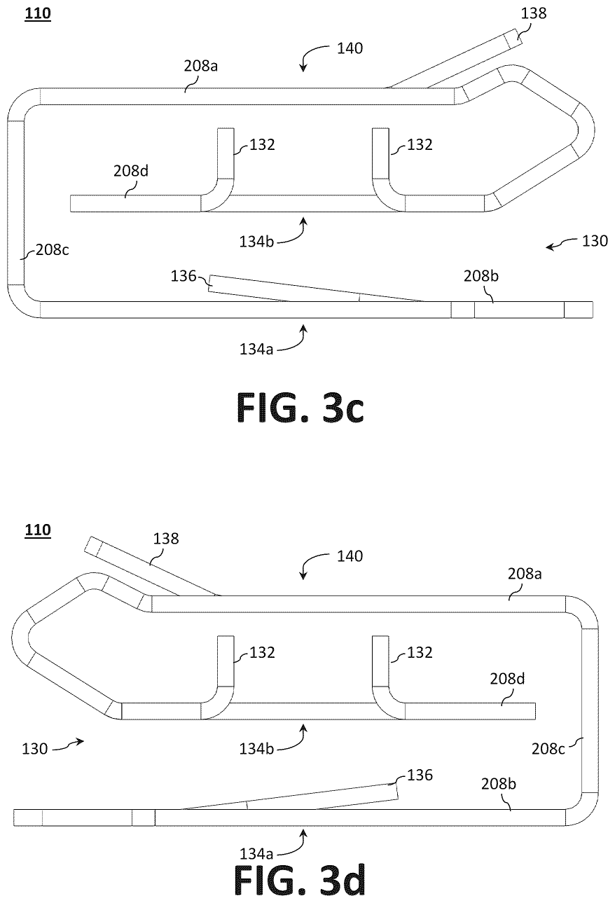

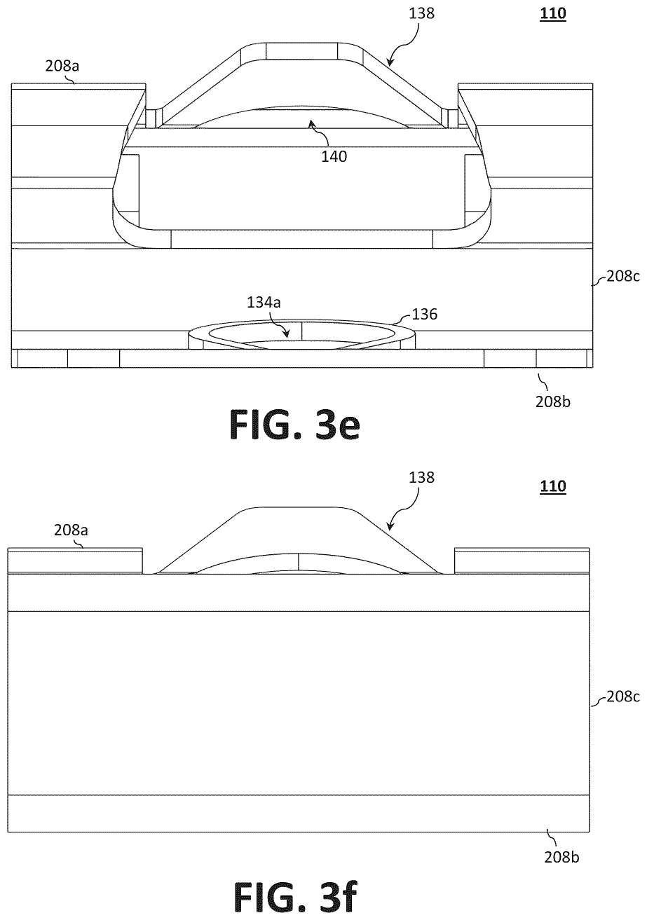

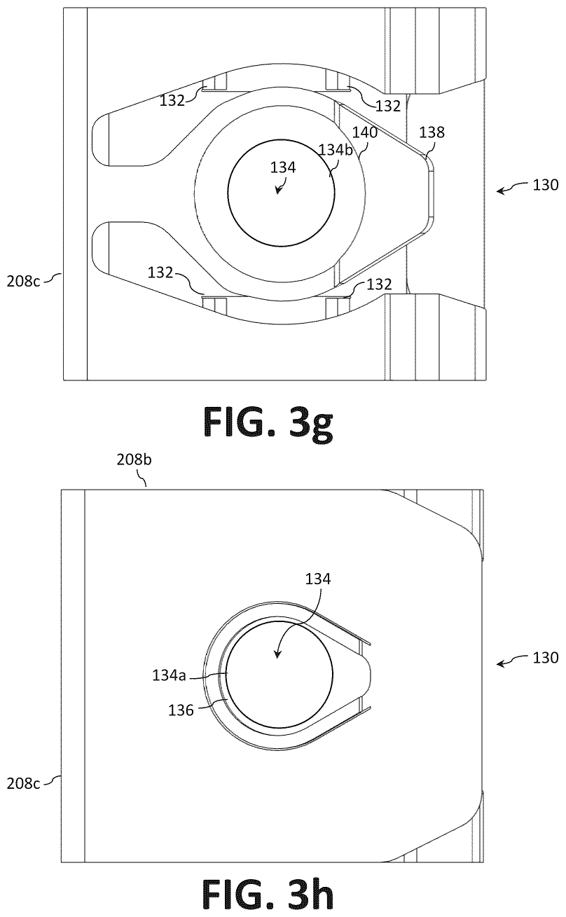

FIGS. 3a through 3f illustrate various views of an example of a retainer clip 110 for the fastening system 100 with the nut insert 112 omitted for clarity. Specifically, FIGS. 3a and 3b illustrate, respectively, topside and underside isometric views of a retainer clip 110 of the retainer assembly 102 in accordance with an aspect of this disclosure. FIGS. 3c and 3d illustrate first and second side elevation assembled views of the retainer clip 110, while FIGS. 3e and 3f illustrate, respectively, front and rear views of the retainer clip 110 and FIGS. 3g and 3h illustrate, respectively, top and bottom plan views of the retainer clip 110. As noted, the retainer clip 110 is a stamped-metal component. As such, the various features of the retainer clip 110 (e.g., nut recess 142, anti-rotation features 132, etc.) can be stamped and/or punched from the material of the body portion 208 and bent to shape.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

1. A retainer assembly for attaching a first component having a first opening relative to a second component having a second opening, the retainer assembly comprising:
a nut insert comprising a bore configured to engaged a shank of a fastener, wherein the nut insert comprises a ferrous material; and
a retainer clip comprising a nut recess that is configured to receive and retain the nut insert, wherein the retainer clip comprises,
a first planar portion and a second planar portion that are resiliently connected via a sidewall to define a channel, and
a nut base plate resiliently connected to the first planar portion and extending into the channel.

2. The retainer assembly of claim 1, wherein the retainer clip is a stamped-metal component.

3. The retainer assembly of claim 1, wherein the channel is configured to receive and to secure the first component and the second component between the nut base plate and the second planar portion.

4. The retainer assembly of claim 1, wherein the retainer clip comprises one or more upward-turned flanges configured to provide resistance to torque during assembly of the nut insert with the shank of the fastener.

5. The retainer assembly of claim 1, wherein the nut insert comprises a collar and a flange, wherein the collar defines the bore.

6. The retainer assembly of claim 1, wherein the retainer clip further comprises a tongue resiliently coupled to the first planar portion and configured to secure a least a portion of the nut insert between the tongue and the base plate.

7. The retainer assembly of claim 6, wherein the tongue defines a tongue opening configured to receive a collar of the nut insert.

8. The retainer assembly of claim 1, wherein the nut base plate is resiliently connected to the first planar portion via a sequence of bends.

9. The retainer assembly of claim 1, wherein the retainer clip comprises a guide lip positioned adjacent an opening to the channel that is configured to guide the first component or the second component into the channel and between the nut base plate and the second planar portion.

10. The retainer assembly of claim 1, wherein the bore is not threaded and configured to accommodate a shank that is thread-forming.

11. The retainer assembly of claim 1, wherein the nut base plate and the second planar portion collectively define a fastener passage to receive the shank therethrough.

12. The retainer assembly of claim 1, wherein the nut base plate comprises one or more upward-turned flanges at a perimeter of the nut recess configured to mitigate rotation of the fastener relative to the nut base plate.

13. A retainer assembly for attaching a first component having a first opening relative to a second component having a second opening, the retainer assembly comprising:
a ferrous nut insert comprising a collar and a flange, wherein the collar defines a bore that is configured to engaged a shank of a fastener; and
a stamped-metal retainer clip comprising a nut recess that is configured to receive and retain the ferrous nut insert, wherein the stamped-metal retainer clip comprises,
a first planar portion and a second planar portion that are resiliently connected via a sidewall to define a channel, and
a nut base plate resiliently connected to the first planar portion and extending into the channel.

14. The retainer assembly of claim 13, wherein the stamped-metal retainer clip further comprises a tongue resiliently coupled to the first planar portion and configured to secure a least a portion of the nut insert between the tongue and the base plate.

15. The retainer assembly of claim 14, wherein the tongue comprises a tongue opening configured to receive a portion of the collar.

16. The retainer assembly of claim 13, wherein the nut base plate comprises one or more upward-turned flanges at a perimeter of the nut recess configured to mitigate rotation of the fastener relative to the nut base plate.

17. A retainer assembly for attaching a first component having a first opening relative to a second component having a second opening, the retainer assembly comprising:
a nut insert comprising a bore configured to engaged a shank of a fastener, wherein the nut insert comprises a ferrous material; and
a stamped-metal retainer clip comprising a nut recess that is configured to receive and retain the nut insert, wherein the retainer clip comprises,
a first planar portion and a second planar portion that are resiliently connected via a sidewall to define a channel,
a nut base plate resiliently connected to the first planar portion and extending into the channel, and
one or more upward-turned flanges at a perimeter of the nut recess configured to mitigate rotation of the fastener relative to the nut base plate.

18. The retainer assembly of claim 17, wherein the channel is configured to receive and to secure the first component and the second component between the nut base plate and the second planar portion.

19. The retainer assembly of claim 17, wherein the stamped-metal retainer clip further comprises a tongue resiliently coupled to the first planar portion and configured to secure a least a portion of the nut insert between the tongue and the base plate.

20. The retainer assembly of claim 1, wherein the nut base plate is resiliently connected to the first planar portion via a sequence of bends, which defines a guide lip adjacent an opening to the channel that is configured to guide the first component or the second component into the channel and between the nut base plate and the second planar portion.
